(19) United States
(12) Patent Application Publication
(10) Pub. No.: US 2024/0133697 A1
(43) Pub. Date: Apr. 25, 2024

(54) Reconciliation of Map Data and Sensor Data

(71) Applicant: ZF Friedrichshafen AG, Friedrichshafen (DE)

(72) Inventors: Elam Parithi Balasubramanian, Ravensburg (DE); Yue Yao, Berlin (DE)

(21) Appl. No.: 18/556,747

(22) PCT Filed: Apr. 3, 2022
(86) PCT No.: PCT/EP2022/058842

§ 371 Date: Oct. 22, 2023

(30) Foreign Application Priority Data
Apr. 22, 2021 (DE) 10 2021 204 063.2

(51) Int. Cl. G01C 21/30; B60W 60/00; G01C 21/36; G06V 20/58

(52) U.S. Cl. CPC G01C 21/30; B60W 60/001; G01C 21/3602; G06V 20/582

(57) ABSTRACT

A device (14) for fusing sensor data with map data, includes: an input interface (24) for receiving sensor data of a surroundings sensor (18) with information regarding objects in the surroundings of a vehicle (12) and for receiving map data with information regarding the vehicle surroundings; an evaluation unit (26) for recognizing visible traffic signs (20) in the vehicle surroundings on the basis of the sensor data and for reading out known traffic signs in the vehicle surroundings from the map data; and an assignment unit (28) for assigning the visible traffic signs to the known traffic signs and for determining a certainty parameter which indicates a probability of a correct assignment.

### CROSS-REFERENCE TO RELATED APPLICATIONS

The present application is related and has right of priority to German Patent Application No. DE102021204063.2 filed on Apr. 23, 2021 and is a U.S. national phase of PCT/EP2022/058842 filed Apr. 4, 2022, both of which are incorporated by reference in their entireties for all purposes.

### FIELD OF THE INVENTION

The present invention relates generally to a device for fusing sensor data with map data. The present invention also relates generally to a control device for the open-loop control of an autonomous or semi-autonomous vehicle and to a system for the open-loop control of an autonomous or semi-autonomous vehicle. The invention also relates generally to a method and to a computer program product.

### BACKGROUND

Modern vehicles (automobiles, trucks, motorcycles, etc.) include a multitude of sensors (radar, LIDAR, camera, ultrasound, etc.), which provide information to a vehicle driver or a control system of the vehicle. With such surroundings sensors, the surroundings of the vehicle and objects in these surroundings (other vehicles, infrastructure objects, persons, moving objects, etc.) are detected. Based on the gathered data, a model of the vehicle surroundings can be generated and changes in these vehicle surroundings can be responded to. In particular, a driving function of the vehicle can be carried out in a semi-autonomous or fully autonomous manner.

In addition to sensor data, the evaluation and control algorithms are also increasingly based on map data. Map data are understood to be, in particular, known information regarding roadways, lanes on these roadways, and objects in the surroundings. These map data are then used as the basis for the short-term and mid-term route planning, but now also more and more as a starting point for the actuation of a driving function or a driver assistance function. The sensor data of the surroundings sensors are considered and evaluated in combination with the map data.

One challenge relates to the fusion of the information obtained via the surroundings sensors with the map data. Map data, in particular high-resolution map data, include detailed information regarding the surroundings of the vehicle and can improve the decision-making in autonomous or semi-autonomous vehicles. It may even be possible to carry out functions of a semi-autonomous or autonomous vehicle at least partially and/or temporarily exclusively on the basis of map data, for example, in order to compensate for sensor failures. For this purpose, a reliable and robust fusion of map data and sensor data, in particular with respect to a position determination of the vehicle with respect to the map data, is necessary.

In this context, previous approaches for fusing sensor data and map data often place high requirements on the processing power and the computation time. Rapid data processing and, in many cases, even a real-time evaluation is necessary especially when a behavior of an autonomous or semi-autonomous vehicle is to be specified on the basis of sensor data and map data.

Peker et al., “Fusion of Map Matching and Traffic Sign Recognition,” 2014 relates to an approach to the high-performance recognition of traffic signs and to the fusion of the recognized traffic signs with digital maps. A traffic sign is detected by a monochrome camera. Standard navigation maps are used.

### SUMMARY OF THE INVENTION

On the basis thereof, example aspects of the present invention provide an approach for efficiently and reliably fusing sensor data with map data. In particular, an approach is to be provided, which allows for an efficient assignment of map data and surroundings sensor data in real time.

In example embodiments, the present invention relates in a first example aspect to a device for fusing sensor data with map data, including:
an input interface for receiving sensor data of a surroundings sensor with information regarding objects in the surroundings of a vehicle and for receiving map data with information regarding the vehicle surroundings;
an evaluation unit for recognizing visible traffic signs in the vehicle surroundings on the basis of the sensor data and for reading out known traffic signs in the vehicle surroundings from the map data; and
an assignment unit for assigning the visible traffic signs to the known traffic signs and for determining a certainty parameter which indicates a probability of a correct assignment.

In a further example aspect, the present invention relates to a control device for the open-loop control of an autonomous or semi-autonomous vehicle, including:
a receiving interface for receiving a certainty parameter which indicates a reliability of an assignment of visible traffic signs, which are recognized on the basis of sensor data of a surroundings sensor, to known traffic signs which are read out of map data; and
an advance planning unit for planning a behavior of the vehicle on the basis of map data and a determined position of the vehicle with respect to these map data, wherein
the advance planning unit is configured to extend a time horizon of the planning when the received certainty parameter indicates that there is a higher reliability of the assignment than in a preceding time increment.

In addition, one example aspect of the present invention relates to a system for the open-loop control of an autonomous or semi-autonomous vehicle, including:
a device as described above and a control device as described above; and
a surroundings sensor for detecting objects in the surroundings of the vehicle.

Further example aspects of the invention relate to a method designed according to the device, and to a control method designed according to the control device, and to a computer program product with program code for carrying out the steps of the method when the program code is run on a computer. One example aspect of the invention also relates to a storage medium on which a computer program is stored and which, when run on a computer, brings about an execution of the method described herein.

It is understood that the features, which are mentioned above and which will be described in greater detail in the following, are usable not only in the particular combination indicated, but rather also in other combinations or alone, without departing from the scope of the present invention. In particular, the device, the control device, the system, the methods and the computer program products can be designed according to the example embodiments.

According to example aspects of the invention, data of a surroundings sensor and map data are received. Both types of data which are received include information regarding objects in the surroundings of the vehicle. The sensor data are received by at least one surroundings sensor, for example, a radar sensor, a LIDAR sensor, a camera sensor, or an ultrasonic sensor. The map data are received from a map database, which either can be locally arranged or connected via a data connection, in particular via a mobile data connection. Traffic signs are identified in the data of the surroundings sensor system. Traffic signs are read out of the map data. On the basis of the identified and read-out traffic signs, an assignment is then carried out and a certainty parameter is determined, which indicates a reliability of the assignment, in particular a probability of a correct assignment or a confidence.

In contrast to previous approaches, in which an assignment takes place on the basis of a multitude of different detected objects, only traffic signs are taken into account according to example aspects of the invention. The assignment takes place starting from traffic signs. This allows for a considerably simplified and more efficiently calculable assignment. In addition, traffic signs can be recognized with high accuracy on the basis of surroundings sensor data and can be made available in map data with a high degree of reliability. Therefore, a reliable assignment can be provided with reduced computational effort. Due to the determination of a certainty parameter, additional information is provided in the further processing of the data or in the planning of the behavior of an autonomous or semi-autonomous vehicle, the additional information allowing for efficient further processing. In particular, due to the certainty parameter, the time horizon can be adapted to the advance planning of the behavior of the autonomous or semi-autonomous vehicle. When the certainty parameter indicates that there is a high probability of a correct assignment, a longer advance planning time period can be used. The certainty parameter makes it possible to adapt an advance planning of the behavior of an autonomous or semi-autonomous vehicle on the basis of the reliability of an assignment of current sensor data to map data. Safety during operation of the autonomous or semi-autonomous vehicle can be improved.

In one preferred example embodiment, the assignment unit is configured to assign the visible traffic signs to the known traffic signs on the basis of an iterative closest point algorithm. The iterative closest point algorithm (ICP) is usually used for the localization of autonomous systems on the basis of LIDAR point clouds or radar point clouds or semantic points in camera data. This assignment is usually complex with respect to the calculation. By comparison, the assignment of visible traffic signs to known traffic signs according to example aspects of the invention can be calculated considerably more efficiently, since only a comparatively small number of data points must be incorporated. This yields a fast and efficient calculability of the assignment.

In one preferred example embodiment, the assignment unit is configured to determine a one-dimensional value on a predefined scale as a reliability value. In particular, high efficiency of the further processing in the planning of the behavior of the autonomous or semi-autonomous vehicle can be achieved due to the use of an easily calculated, one-dimensional value. For example, a percentage value or a decimal value can be used. Efficient calculability is achieved.

In one preferred example embodiment, the evaluation unit is configured to determine positions of the recognized visible traffic signs and of the read-out known traffic signs. The assignment unit is designed to assign the recognized visible traffic signs to the read-out known traffic signs on the basis of the determined positions. Preferably, positions of the traffic signs are read out and determined. The assignment is therefore based in particular on the positions of the signs. A position of the vehicle with respect to the surroundings and with respect to the map data can then be determined. For most applications, the position is an important prerequisite in the planning of the behavior of an autonomous or semi-autonomous vehicle. Precise knowledge of a position allows the planning horizon to be extended.

In one preferred example embodiment, the assignment unit is designed to minimize an average square distance between the positions of the recognized visible traffic signs and of the read-out known traffic signs. An average square distance is an efficiently calculable error measure and therefore offers a simple possibility for finding an assignment.

In one preferred example embodiment, the evaluation unit is designed to determine classes of the recognized visible traffic signs and of the read-out known traffic signs. The assignment unit is designed to assign the recognized visible traffic signs to the read-out known traffic signs on the basis of the determined classes. A class of a traffic sign is understood to be the type of traffic sign in particular with respect to the message of the traffic sign regarding traffic rules or other regulations. A class of traffic signs can be, for example, stop signs, “no stopping” signs, etc. This type or class of traffic signs is taken into account in the assignment. The reliability of the assignment is therefore further improved. An efficient assignment is achieved.

In one preferred example embodiment, the evaluation unit is designed to determine orientations of the recognized visible traffic signs and of the read-out known traffic signs. The assignment unit is designed to assign the recognized visible traffic signs to the read-out known traffic signs on the basis of the determined orientations. An orientation is understood to be an orientation of the traffic signs. In particular, an orientation with respect to a two-dimensional roadway plane is used. The direction in which the traffic sign points is taken into account. The orientation is considered to be additional information. This yields a further improved reliability of the assignment. The orientation can usually be efficiently derived from the data of the surroundings sensor and also from the map data.

An object in the surroundings of a vehicle can be, in particular, a vehicle, a cyclist, a pedestrian, an animal or a static object, such as an automobile tire lying on the roadway, or a traffic sign, etc. The surroundings can be, in particular, the surroundings of a vehicle or a region which is viewable from the vehicle. The surroundings can also be defined by a radius or another distance. Map data denote, in the present case, in particular to a representation of the surroundings or of an area with respect to roads, bike paths, footpaths and traffic signs, and other objects, etc. Map data can be present in any type of format. An autonomous or semi-autonomous vehicle is a vehicle in which a computer unit provides at least a portion of a driving function. A traffic sign is a sign installed in the region of a roadway with information regarding the traffic rules, objects and attractions in the surroundings, regarding destinations and distances, regarding directions, etc.

### BRIEF DESCRIPTION OF THE DRAWINGS

Example aspects of the invention are described and explained in greater detail in the following with reference to some selected exemplary embodiments in conjunction with the attached drawings, in which:

FIG. 1 shows a schematic view of a system according to example aspects of the invention for the open-loop control of an autonomous or semi-autonomous vehicle;

FIG. 2 shows a schematic view of a device according to example aspects of the invention for fusing sensor data with map data;

FIG. 3 shows a schematic view of a control device according to example aspects of the invention;

FIG. 4 shows a schematic view of the approach according to example aspects of the invention for fusing sensor data with map data;

FIG. 5 shows a schematic view of an assignment which has a high probability of being correct;

FIG. 6 shows a schematic view of an assignment which has a reduced probability of being correct;

FIG. 7 shows a schematic view of a situation in which a reliable assignment cannot be achieved; and

FIG. 8 shows a schematic view of a method according to example aspects of the invention for fusing sensor data with map data.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

FIG. 1 schematically shows a system 10 according to example aspects of the invention for the open-loop control of an autonomous or semi-autonomous vehicle 12. The system 10 includes a device 14 for fusing sensor data with map data, a control device 16 for the open-loop control of the vehicle 12 and a surroundings sensor 18 for detecting objects in the surroundings of the vehicle 12. In the exemplary embodiment shown, the system 10 is integrated into the vehicle 12. The view is to be understood as a sectional side view of the vehicle 12 on a roadway. The surroundings of the vehicle 12 include, in particular, traffic signs 20 which are detected as objects by the surroundings sensor 18. The device 14 and the control device 16 can be integrated, for example, into a control unit or into a central computer of the vehicle 12. It is also possible that the device 14 or the control device 16 are integrated into the surroundings sensor 18. The surroundings sensor 18 can be mounted, in particular, on the vehicle 12. It is also possible, however, that the device 14, the control device 16 and/or the surroundings sensor 18 are separate, for example, being integrated into a smartphone.

According to example aspects of the invention, the surroundings of the vehicle 12 are detected by the surroundings sensor 18. Traffic signs 20 are recognized on the basis of the sensor data. In addition, the device 14 is designed to receive map data. In the exemplary embodiment shown, the map data are received from a central server 22 via a mobile data connection. It is also possible, however, that the map data are received from a database arranged within the vehicle 12, within the device 14 itself or at another point. In the device, the sensor data of the surroundings sensor 18 are fused or reconciled with the map data. In particular, an assignment of sensor data to map data is carried out on the basis of the traffic signs 20. A certainty parameter is calculated, which expresses a probability of a correct assignment.

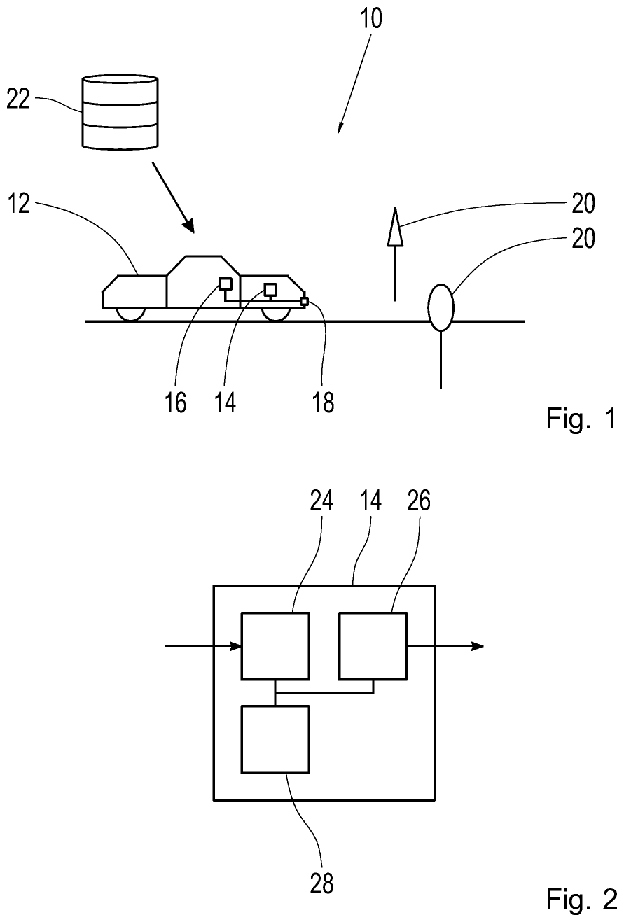

FIG. 2 schematically shows a device 14 according to example aspects of the invention for fusing sensor data with map data. The device includes an input interface 24, an evaluation unit 26 and an assignment unit 28. The units and interfaces can be used partially or completely in software and/or in hardware. In particular, the units can be formed as a processor, processor modules or as software for a processor. The device 14 can be formed, in particular, as a control unit or a central computer of an autonomous or semi-autonomous vehicle or as software for a control unit or a central computer of an autonomous or semi-autonomous vehicle.

Sensor data of the surroundings sensor as well as map data are received via the input interface 24. For this purpose, the input interface 24 is connected to a surroundings sensor, such as, for example, a radar sensor, a LIDAR sensor, a camera sensor or an ultrasonic sensor. It is understood that the input interface can also be connected to multiple sensors and can receive sensor data which has already been preprocessed in a corresponding way. In particular, for example, a point cloud or a camera recording can be received. The map data can be received either from a local database or from a remote database.

Visible traffic signs are recognized in the evaluation unit 26 by an analysis of the received sensor data. Visible traffic signs are understood to be, in particular, traffic signs which are located in a field of view of the surroundings sensor. This recognition of visible traffic signs can take place on the basis of algorithms of the sensor data processing and, in particular, of the image evaluation. In particular, pattern recognition from image data can be carried out.

Furthermore, known traffic signs are read out of the map data in the evaluation unit 26. Depending on the data format of the map data, an appropriate query is used or an evaluation is carried out for this purpose. Either a query of all traffic signs present in the map data is carried out or only traffic signs in the area of a current position or a position estimation of the vehicle are read out. Recognizing the traffic signs and reading out the traffic signs relates in particular to a position being determined and read out in an appropriate coordinate system. For example, a vehicle coordinate system can be used to determine the positions of the visible traffic signs from the sensor data. In a corresponding way, a coordinate system of the map data can be used to read out the positions of the traffic signs contained therein. In addition, a recognition of the traffic signs is understood to also optionally be a determination of an orientation in the sense of an orientation with respect to the corresponding coordinate system. It is also possible that a class, i.e., a type of the traffic sign in terms of the meaning, is determined on the basis of the sensor data and is read out of the map data. It is therefore determined whether the traffic sign is, for example, a stop sign, a yield sign, etc.

Proceeding from the recognized visible traffic signs and the read-out known traffic signs, an assignment is then carried out in the assignment unit 28 and a probability of a correct assignment is determined. For this purpose, the traffic signs which are recognized on the basis of the sensor data are matched as closely as possible to the traffic signs which have been read out on the basis of the map data by an appropriate assignment algorithm. In particular, positions of the signs can be referred to for the assignment. In addition, the orientation and/or the determined class of the traffic signs can also be incorporated.

In particular, an iterative closest point algorithm can be used for the assignment. In order to determine the quality of the assignment, i.e., the certainty parameter, for example, a root-mean-square error can be determined in the particular positions. The certainty parameter then indicates how reliable the assignment is. In particular, the certainty parameter provides a measure as to whether the assignment is reliable or whether an assignment could not be carried out. The certainty parameter is determined, in particular, on a predefined scale. For example, a percentage can be used. The scale can also be open at one end.

The output of the iterative closest point algorithm usually includes an indication of a translational and rotational relationship between the sensor data and the map data and between the positions of the recognized traffic signs in the sensor data and the positions of the traffic signs which are read out of the maps. On the basis thereof, in particular, a current position of the surroundings sensor and of the vehicle with respect to the map data can be derived. In particular, two criteria can be taken as the basis for calculating the certainty parameter. On the one hand, an assignment error of the iterative closest point algorithm can be taken as the basis. On the other hand, an uncertainty in the localization, for example, in the form of a covariance or of another measure, can be used as the certainty parameter or as the basis for calculating the certainty parameter.

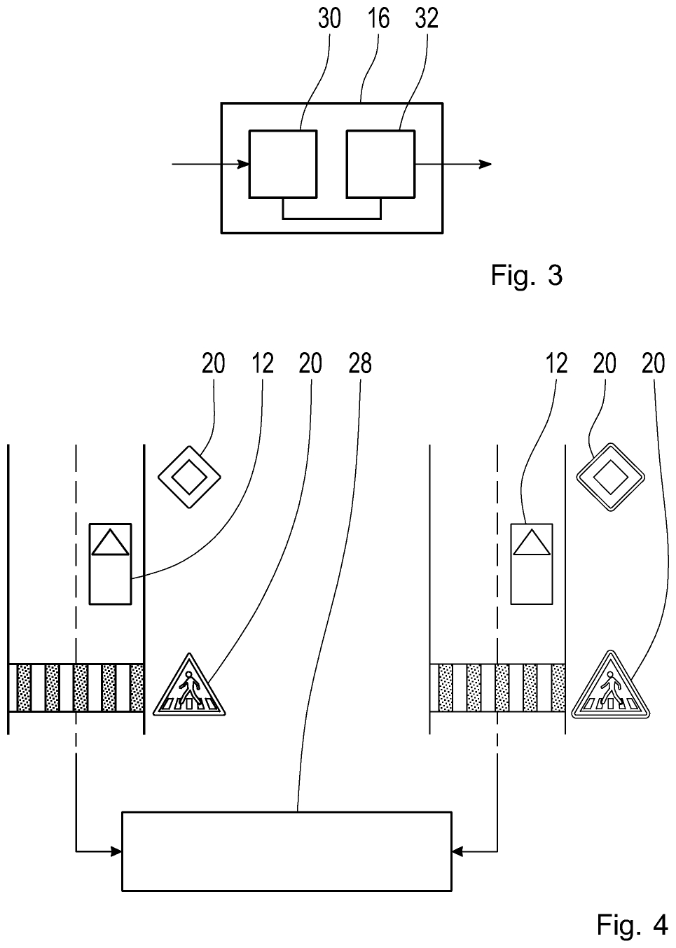

FIG. 3 schematically shows a control device 16 according to example aspects of the invention for the open-loop control of an autonomous or semi-autonomous vehicle. The control device 16 includes an input interface 30 and an advance planning unit 32. As described above, the units and interfaces can be used partially or completely in software and/or in hardware. The control device 16 can be designed together with the device 14.

The certainty parameter is received via the receiving interface 30. For this purpose, the receiving interface 30 can be connected, in particular, to a device 14 for positioning sensor data and map data.

A behavior of an autonomous or semi-autonomous vehicle is planned in the advance planning unit 32. Planning a behavior of an autonomous or semi-autonomous vehicle is understood to mean, for example, defining short-term routing or making a decision with respect to a braking procedure, an acceleration procedure or an evasive maneuver. The advance planning unit 32 is designed to extend a time horizon of this planning when the certainty parameter indicates a high reliability of the assignment. The advance planning horizon is therefore made dependent upon the previously determined certainty parameter. The more reliable the assignment is between sensor data and map data, the greater is the time horizon of the advance planning.

According to example aspects of the invention, therefore, the certainty parameter is used as the basis for a fusion of the sensor data with map data in further time increments. The higher the certainty parameter is, the more the map data can be relied upon for planning the behavior of the autonomous or semi-autonomous vehicle. In comparison to previous approaches to using point cloud data or semantic data, in which an iterative closest point algorithm is also used for the localization and for the determination of a certainty in the localization and in the assignment, a considerably more efficient calculability is made possible due to the exclusive use of traffic signs according to example aspects of the invention. As a result, for example, a real-time capability of the decision-making of the autonomous or semi-autonomous vehicle can be improved.

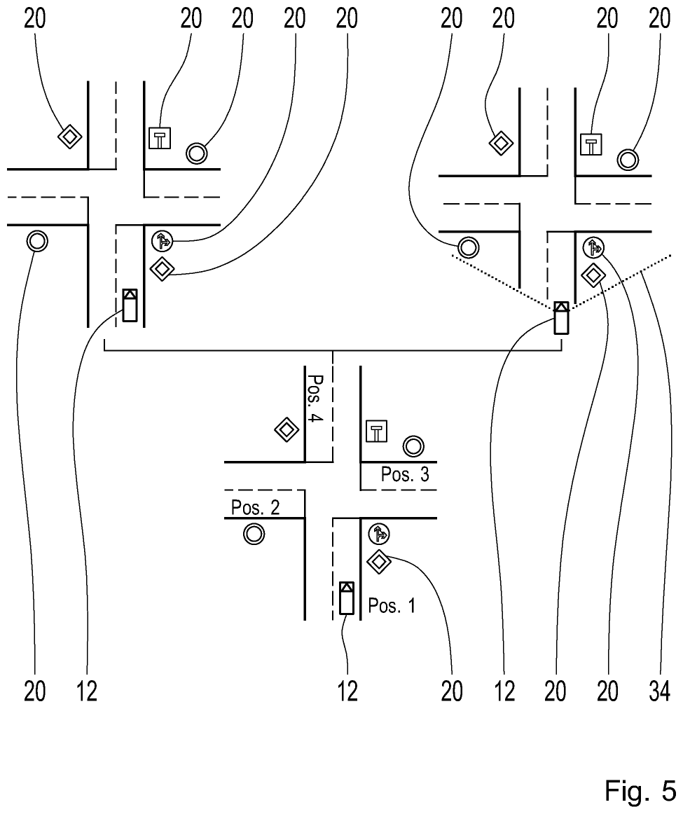

FIGS. 4 through 7 schematically show the approach according to example aspects of the invention for fusing sensor data with map data. The left side in each case represents the evaluation/processing of the map data. The right side relates to the evaluation/processing of the sensor data.

FIG. 4 schematically shows, on the left side, that, according to map data, there are two traffic signs 20 (right of way and pedestrian crossing) in the surroundings of the vehicle 12 and these are read out. As shown on the right side, the two traffic signs 20 in the surroundings of the vehicle 12 are recognized in the same way via the evaluation of the sensor data of the surroundings sensor. After the traffic signs are recognized and read out, an assignment of the visible traffic signs to the known traffic signs is carried out in the assignment unit 28. For this purpose, in particular, an iterative closest point algorithm can be used, the iterative closest point algorithm generating appropriate rotation and translation matrices. A certainty parameter can be determined on the basis of the assignment.

In one exemplary embodiment, this certainty parameter explicitly indicates a probability of a correct assignment. When there is a high probability that an assignment is correct, a control system of an autonomous or semi-autonomous vehicle can use the map data to plan a behavior of the autonomous or semi-autonomous vehicle. For example, the certainty parameter can provide information in a binary manner regarding a correct/incorrect assignment.

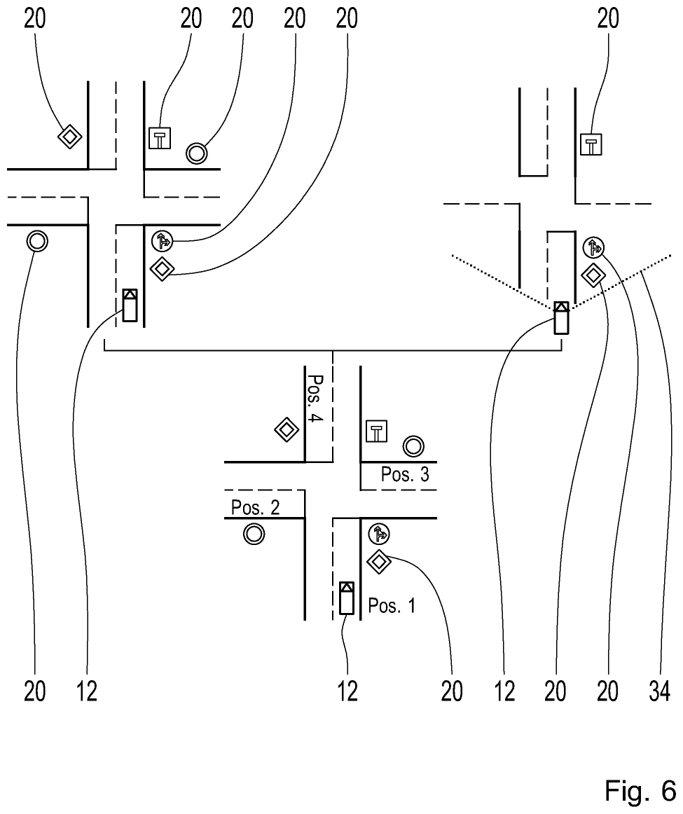

FIG. 5 schematically shows a traffic situation. A vehicle 12 and the traffic signs 20 which can be read out of map data and which are located in the vehicle surroundings are shown on the left side (at the top). Shown on the right (at the top) is the perception of the surroundings sensor system of the vehicle 12 within the field of view 34 of the surroundings sensor. As shown at the bottom, the vehicle 12 is clearly located at position 1, since there is complete match between the traffic signs 20 which were recognized on the basis of the sensor data and the traffic signs 20 which were read out of the map data. The certainty parameter therefore indicates that there is a high probability of a correct assignment.

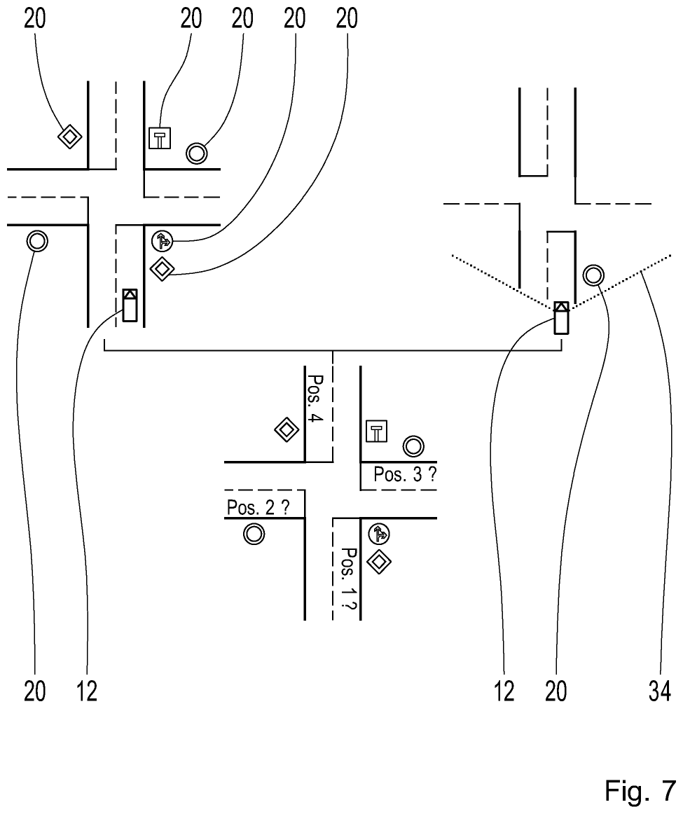

FIG. 6 schematically shows a case in which, as indicated on the right in FIG. 6, only three traffic signs 20 are recognized by the surroundings sensor on the vehicle 12 within the field of view 34 of the surroundings sensor. The corresponding map data of the same surroundings are shown on the left side, according to which map data a total of six traffic signs 20 must be present. Since a correct assignment can nevertheless be carried out on the basis of the orientation, the position and the class of the traffic signs, position 1 is ultimately determined again to be the position of the vehicle. The certainty parameter indicates in this case as well that there is a high probability of a correct assignment.

FIG. 7 shows a situation in which only one single traffic sign 20 is recognized by the surroundings sensor system on the vehicle 12 in the field of view 34 of the surroundings sensor. The comparison with the map data shown on the left side, in which six traffic signs 20 are present in the corresponding region, then yields ambiguity between the positions 1, 2 and 3. At all three positions there is a round traffic sign 20 on the right ahead of the vehicle 12. A reliable correct assignment therefore cannot be carried out. The certainty parameter indicates that there is a low probability of a correct assignment.

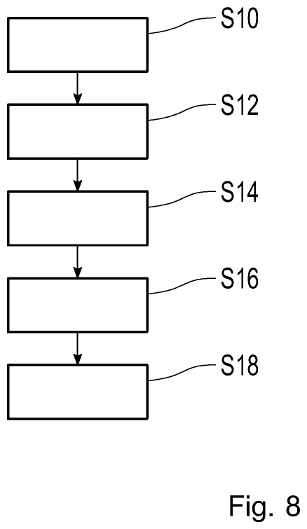

FIG. 8 schematically shows a method according to example aspects of the invention for fusing sensor data with map data. The method includes receiving S10 sensor data and map data, recognizing S12 visible traffic signs, reading out S14 known traffic signs, assigning S16 the visible traffic signs to the known traffic signs and determining S18 a certainty parameter. The method can be implemented, in particular, in the form of software which is run on a processor of a vehicle or of a vehicle control unit. It is understood that the vehicle can also be implemented as a smartphone app.

Example aspects of the invention have been comprehensively described and explained with reference to the drawings and the description. The description and the explanation are to be understood as an example and are not to be understood as limiting. The invention is not limited to the disclosed embodiments. Other embodiments or variations result for a person skilled in the art within the scope of the utilization of the present invention and within the scope of a precise analysis of the drawings, the disclosure, and the following claims.

In the claims, the words “comprise” and “comprising” do not rule out the presence of further elements or steps. The indefinite article “a” does not rule out the presence of a plurality. A single element or a single unit can carry out the functions of several of the units mentioned in the claims. An element, a unit, an interface, a device, and a system can be partially or completely converted into hardware and/or into software. The mere mention of a few measures in multiple various dependent claims is not to be understood to mean that a combination of these measures cannot also be advantageously utilized. A computer program can be stored/distributed on a non-volatile data carrier, for example, on an optical memory or on a solid state drive (SSD). A computer program can be distributed together with hardware and/or as part of a piece of hardware, for example, by means of the Internet or by means of hard-wired or wireless communication systems. Reference characters in the patent claims are not to be understood as limiting.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 system
12 vehicle
14 device
16 control device
18 surroundings sensor
20 traffic sign
22 central server
24 input interface
26 evaluation unit
28 assignment unit
30 receiving interface
32 advance planning unit
34 field of view

1-11: (canceled)

12. A device (14) for fusing sensor data with map data, comprising:
an input interface (24) configured for receiving sensor data of a surroundings sensor (18) with data corresponding to objects in the surroundings of a vehicle (12) and for receiving map data with data corresponding to the surroundings of the vehicle (12);
an evaluation unit (26) configured for recognizing visible traffic signs (20) in the surroundings of the vehicle (12) based at least in part on the sensor data and for reading out known traffic signs in the surroundings of the vehicle (12) from the map data; and
an assignment unit (28) configured for assigning the visible traffic signs to the known traffic signs and for determining a certainty parameter that indicates a probability of a correct assignment.

13. The device (14) of claim 12, wherein the assignment unit (28) is configured for assigning the recognized visible traffic signs (20) to the known traffic signs with an iterative closest point algorithm.

14. The device (14) of claim 12, wherein the assignment unit (28) is configured for determining a one-dimensional value on a predefined scale as a reliability value.

15. The device (14) of claim 12, wherein:
the evaluation unit (26) is configured for determining positions of the recognized visible traffic signs (20) and of the known traffic signs; and
the assignment unit (28) is configured for assigning the recognized visible traffic signs to the read-out known traffic signs based at least in part on the determined positions.

16. The device (14) of claim 15, wherein the assignment unit (28) is configured for minimizing an average square distance between the positions of the recognized visible traffic signs (20) and the known traffic signs.

17. The device (14) of claim 12, wherein:
the evaluation unit (26) is configured for determining classes of the recognized visible traffic signs (20) and of the known traffic signs; and
the assignment unit (28) is configured for assigning the recognized visible traffic signs to the known traffic signs based at least in part on the determined classes.

18. The device (14) of claim 12, wherein:
the evaluation unit (26) is configured for determining orientations of the recognized visible traffic signs (20) and of the known traffic signs; and
the assignment unit (28) is configured for assigning the recognized visible traffic signs to the known traffic signs based at least in part on the determined orientations.

19. A control device (16) for open-loop control of an autonomous or semi-autonomous vehicle (12), comprising:
a receiving interface (30) configured for receiving a certainty parameter indicative of a reliability of an assignment of visible traffic signs (20), which are recognized on the basis of sensor data of a surroundings sensor (18), to known traffic signs read out of map data; and
an advance planning unit (32) configured for planning a behavior of the vehicle based at least in part on the map data and a determined position of the vehicle with respect to the map data,
wherein the advance planning unit is configured for extending a time horizon of the planning when the certainty parameter indicates that there is a greater reliability of the assignment than in a preceding time increment.

20. A system (10) for open-loop control of an autonomous or semi-autonomous vehicle (12), comprising:
a surroundings sensor (18) configured for detecting objects in a surroundings of the vehicle (12);
a device (14) for fusing sensor data with map data, the device (14) comprising
an input interface (24) configured for receiving sensor data of the surroundings sensor (18) with data corresponding to objects in the surroundings of the vehicle (12) and for receiving map data with data corresponding to the surroundings of the vehicle (12),
an evaluation unit (26) configured for recognizing visible traffic signs (20) in the surroundings of the vehicle (12) based at least in part on the sensor data and for reading out known traffic signs in the surroundings of the vehicle (12) from the map data, and
an assignment unit (28) configured for assigning the visible traffic signs to the known traffic signs and for determining a certainty parameter that indicates a probability of a correct assignment; and
a control device (16) for the open-loop control of the vehicle (12), the control device (16) comprising
a receiving interface (30) configured for receiving the certainty parameter, and
an advance planning unit (32) configured for planning a behavior of the vehicle based at least in part on the map data and a determined position of the vehicle with respect to the map data,
wherein the advance planning unit is configured for extending a time horizon of the planning when the certainty parameter indicates that there is a greater reliability of the assignment than in a preceding time increment.

21. A method for fusing sensor data with map data, comprising:
receiving (S10) sensor data of a surroundings sensor (18) with data corresponding to objects in a surroundings of a vehicle (12)
receiving map data with data corresponding to the surroundings of the vehicle (12);
recognizing (S12) visible traffic signs (20) in the surroundings of the vehicle (12) based at least in part on the sensor data;
reading out (S14) known traffic signs in the surroundings of the vehicle (12) from the map data; and
assigning (S16) the visible traffic signs to the known traffic signs and determining (S18) a certainty parameter indicative of a probability of a correct assignment.

22. A non-transitory computer program product, comprising program code for implementing the method of claim 21 when the program code is executed on a computer.
